(19) United States
(12) Patent Application Publication
(10) Pub. No.: US 2014/0158877 A1
(43) Pub. Date: Jun. 12, 2014

(54) HYDROGEN RESISTANT DOWNHOLE OPTICAL FIBER SENSING

(71) Applicants: Paul F. Wysocki, Blacksburg, VA (US); Roger Glen Duncan, Christiansburg, VA (US); Christopher H. Lambert, Blacksburg, VA (US); Brooks A. Childers, Christiansburg, VA (US)

(72) Inventors: Paul F. Wysocki, Blacksburg, VA (US); Roger Glen Duncan, Christiansburg, VA (US); Christopher H. Lambert, Blacksburg, VA (US); Brooks A. Childers, Christiansburg, VA (US)

(21) Appl. No.: 13/711,133

(22) Filed: Dec. 11, 2012

(51) Int. Cl. G01V 8/02; G01V 13/00

(52) U.S. Cl. CPC G01V 8/02; G01V 13/00
USPC 250/269.1; 29/428; 29/592.1

(57) ABSTRACT

An apparatus for estimating at least one parameter in a downhole environment includes: an optical fiber configured to be disposed in a borehole, the optical fiber including a core having a first index of refraction and a cladding surrounding the core and having a second index of refraction that is lower than the first index of refraction, at least a portion of the core being made from a hydrogen resistant material; at least one fiber Bragg grating (FBG) formed within the hydrogen resistant material; a light source configured to send an optical signal into the optical fiber; and a detector configured to receive a return signal generated by the at least one FBG and generate data representative of the at least one parameter.

### BACKGROUND

Optical fiber sensors are often utilized to obtain various surface and downhole measurements, such as pressure, temperature, stress and strain. Examples of optical fiber sensors include optical fibers having a series of fiber Bragg gratings. The wavelength distribution from such gratings is affected by temperature and strain on the fiber, and thus such fibers can be used to measure temperature and strain, for example.

Some optical fiber sensors utilize cores doped with photosensitive materials. Photosensitive materials such as germanium are utilized to facilitate grating manufacture, but readily react with hydrogen at temperatures in excess of 100 C, which limits the performance in harsh environments such as those downhole. Increases in photosensitive material concentration increase the fiber sensors' sensitivity to hydrogen loss. Thus, optical fibers having highly doped photosensitive cores exhibit high hydrogen induced loss, especially when exposed to downhole environments.

### SUMMARY

An apparatus for estimating at least one parameter in a downhole environment includes: an optical fiber configured to be disposed in a borehole, the optical fiber including a core having a first index of refraction and a cladding surrounding the core and having a second index of refraction that is lower than the first index of refraction, at least a portion of the core being made from a hydrogen resistant material; at least one fiber Bragg grating (FBG) formed within the hydrogen resistant material; a light source configured to send an optical signal into the optical fiber; and a detector configured to receive a return signal generated by the at least one FBG and generate data representative of the at least one parameter.

A method of estimating at least one parameter in a downhole environment includes: disposing an optical fiber in a borehole in an earth formation, the optical fiber including a core having a first index of refraction and a cladding surrounding the core and having a second index of refraction that is lower than the first index of refraction, at least a portion of the core being made from a hydrogen resistant material; transmitting an optical signal into the optical fiber; reflecting a portion of the optical signal by at least one fiber Bragg grating (FBG) formed within the hydrogen resistant material; and detecting the reflected portion of the optical signal and estimating the at least one parameter.

A method of manufacturing an apparatus for estimating at least one parameter in a downhole environment includes: forming at least one fiber Bragg grating (FBG) in a region of a core of an optical fiber, the optical fiber configured to be disposed in a borehole, the region of the core being made from a hydrogen resistant material; and disposing a length of the optical fiber that includes the FBG at a carrier configured to be disposed in a borehole in an earth formation.

### BRIEF DESCRIPTION OF THE DRAWINGS

Referring now to the drawings wherein like elements are numbered alike in the several Figures:

FIG. 1 depicts an exemplary optical fiber sensor;

FIG. 2 is a flow chart illustrating an exemplary method of manufacturing an optical fiber sensor and/or performing downhole measurements.

FIG. 3 depicts a downhole measurement apparatus incorporating the optical fiber sensor of FIG. 1.

### DETAILED DESCRIPTION

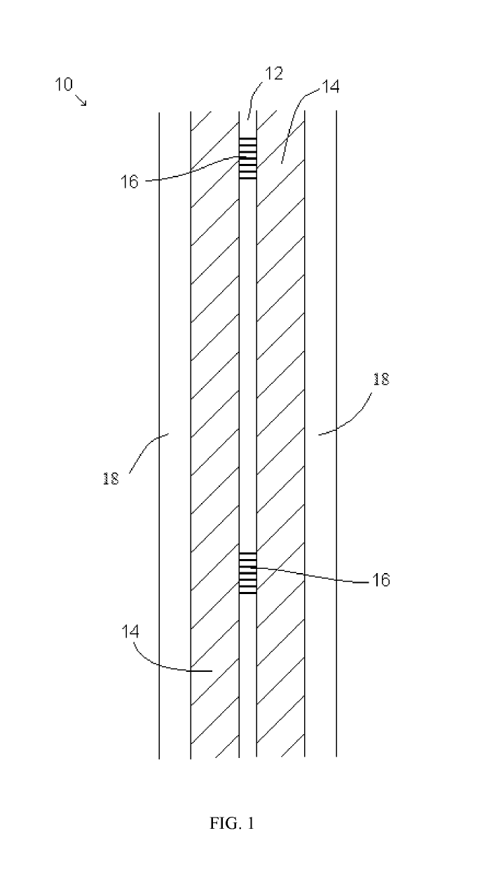

Referring to FIG. 1, a cross-sectional view of an embodiment of an optical fiber sensor 10 is shown. This embodiment of the optical fiber sensor 10 includes at least one core 12 having a first index of refraction and at least one cladding 14 having a second index of refraction that is lower than the first index of refraction. The optical fiber sensor 10 may include a single mode or multi-mode fiber. All or a portion of the core 12 may be made from suitable optically conductive and hydrogen resistant materials including glasses such as silica glass or quartz. The cladding 14 is a doped cladding layer including an optically conductive material such as silica glass that is doped with a dopant having the ability to lower the second index of refraction relative to the undoped material. An example of such cladding dopants includes fluorine. Alternatively, the core may contain a hydrogen resistant material with suitable dopants to raise the index of refraction and the cladding may contain pure silica or doped silica with an index of refraction lower than the core index.

The optical fiber sensor 10 includes at least one measurement unit 16 disposed therein. For example, the measurement unit 16 is a fiber Bragg grating disposed in the core 12 that is configured to reflect a portion of an optical signal as a return signal, which can be detected and/or analyzed to estimate a parameter of the optical fiber 10 and/or a surrounding environment. One or more Bragg gratings are included within the hydrogen resistant core 12 (or at least within a hydrogen resistant portion of the core 12). As described herein, an “optical fiber sensor” may refer to a single optical fiber having measurement units disposed therein, and may also refer to multiple optical fibers. Various other components may be considered a part of an “optical fiber sensor”, such as jackets (e.g., a jacket 18), protective coverings, strength members, cable components, insulating materials and others.

A fiber Bragg grating (FBG) is a permanent periodic refractive index modulation in the core of an optical fiber that extends along a selected length of the core, such as about 1-100 mm. A FBG reflects light within a narrow bandwidth centered at the Bragg wavelength “λ_{B}”. The reflected Bragg wavelength λ_{B} from an FBG change with changes in conditions around the fiber, such as temperature and pressure, sufficient to changes the effective refractive index seen by propagating light and/or the physical grating period of the FBG. By measuring the reflected Bragg wavelength λ_{B}, a FBG can be used as a sensor for measuring such conditions. FBGs can also be used as a pressure sensor by measuring the shift in Bragg wavelength caused by compression of the fiber.

As indicated above, all or part of the length of the core 12 of optical fiber sensor 10 is formed from a hydrogen resistant material in which the gratings are formed. As described herein, a “hydrogen resistant” material is defined as any material that has sufficient optical properties to be used in an optical fiber and that does not react with hydrogen to cause optical loss, or that at least does not react with hydrogen to a degree that results in significant or appreciable optical loss that would negatively affect downhole communications or measurements. Hydrogen resistant materials are thus resistant to effects of hydrogen diffusion into the fiber material (e.g., darkening). Such effects are typically due to absorption of light by various species in the core, such as molecular hydrogen (H₂) or defect sites that react with hydrogen. The hydrogen can come from various sources, including downhole fluids (e.g., injected fluids and/or formation materials), evolution or dissolution from cable materials and oxidation/corrosion. A material need not resist all forms of hydrogen induced darkening to be “hydrogen resistant”. As long as it is resistant to darkening that causes absorption in the optical wavelength band of operation of a sensor apparatus or system (e.g., an apparatus 30 described below), the material may be considered to be “hydrogen-resistant”

In one embodiment, a “hydrogen resistant” material is a material that has not been doped with various dopants that are known to increase the reaction of the material with hydrogen gas and the formation of optical absorption bands in a hydrogen-rich environment. Many, but not all, such materials are sometimes used to raise the index of refraction in the core of optical fibers. Such a “hydrogen resistant” core material is generally not doped with a photosensitive material such as germanium or phosphorous or has a substantially reduced amount of these dopants as compared with typical optical fibers. Thus, a hydrogen resistant fiber may include any fiber having a core doped to produce substantially less hydrogen induced loss than standard communication grade germanium-doped optical fibers (e.g. Coming SMF28).

Photosensitive dopants typically cause an optical material to exhibit a substantial index of refraction change when exposed to optical radiation. It is well known that certain dopants or materials added to a silica based fiber make it photosensitive, particularly, allowing the writing of FBGs by exposure to periodically varying optical intensity at particular wavelengths, typically in the near ultraviolet range. Hydrogen resistant core materials as described herein are not doped with photosensitive materials including germanium, phosphorous, boron, tin, nitrogen, europium, cerium, or other materials that are known to make the core photosensitive. In the absence of these dopants, it is difficult to produce a low loss core with a refractive index higher than that of pure silica. Consequently, such non-photosensitive fibers might have a refractive index lowered in the cladding by the inclusion of a fluorine dopant (or other index lowering dopant). Although fluorine may diffuse into the core from the cladding, fluorine is not considered photosensitive or reactive with hydrogen and thus a core with some fluorine therein is still considered to be “hydrogen resistant” as understood herein.

Exemplary hydrogen resistant core materials include un-doped silica or other optical materials, i.e., materials that have not been doped with a photosensitive material that allow for the writing of FBGs and also increase hydrogen reactivity. Hydrogen resistant materials as described herein may also include “pure core” silica, which is at least substantially made only from silica. An exemplary optical fiber having a hydrogen resistant core is Baker Hughes' CoreBright^{SM} fiber. Hydrogen resistant materials as described herein are in contrast to typical fiber sensor core materials, which are doped with photosensitive materials such as germanium and phosphorous to facilitate writing FBGs therein. However, such dopants have been discovered to increase hydrogen absorption and lead to increased transmission losses.

Fiber sensors formed using hydrogen resistant cores avoid a significant effect experienced by typical Type I fibers, in which gratings are formed by exposing photosensitive materials (e.g., germanium) to UV light. Type I fibers, which include photosensitive material, are most often susceptible to hydrogen induced loss due to the presence of the photosensitive material. The hydrogen resistant materials described herein do not experience this effect due to the lack of these dopants, and thus exhibit significantly less attenuation when downhole as compared to conventional Bragg grating sensor fibers that include germanium or other photosensitive dopants.

Another property of the hydrogen resistant material described herein is that the material is at least substantially free of the types of defects that are typically formed in Type II gratings and can bond with hydrogen. Such defects in the structure of a core can react with hydrogen to form species that absorb a relatively wide wavelength range. For example, defects in a pure silica core occur due to deviations from the regular tetrahedral lattice formed in the silica. Examples of such defects include defects occurring due to fiber drawing and manufacturing processes, and physical damage that is induced in a Type II fiber core having gratings that are a result of damage to the material by exposure to high intensity light.

in one embodiment, gratings are formed in the hydrogen resistant core using high intensity and high peak power femtosecond pulsed lasers. Such gratings can be written directly into hydrogen resistant core fiber or written through an outer polymer coating, thus simplifying production of the gratings. In addition, gratings formed via femtosecond lasers do not require photosensitive materials and produce fewer defects than other techniques (e.g., conventional techniques for manufacturing Type II gratings). Furthermore, such femtosecond pulsed FBGs are stable at high temperatures and therefore can be used in downhole environments, thus facilitating the combination of FBG sensors and the hydrogen resistance required for such applications. Prior to such femtosecond laser methods for writing such FBGs in any glass material, it was not deemed possible or feasible in the art to write FBGs in hydrogen-resistant materials.

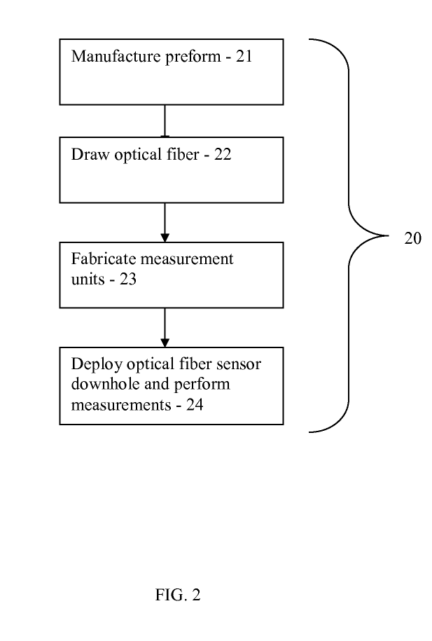

FIG. 2 illustrates a method 20 of manufacturing an optical fiber sensor and/or performing measurements using the optical fiber sensor. The method 20 includes one or more stages 21-24. In one embodiment, the method 20 includes the execution of all of stages 21-24 in the order described. However, certain stages may be omitted, stages may be added, or the order of the stages changed.

In the first stage 21, an optical fiber preform is manufactured utilizing any of a variety of suitable methods. Such methods include deposition methods such as chemical vapor deposition (CVD), modified chemical vapor deposition (MCVD), plasma chemical vapor deposition (PCVD), vapor-phase axial deposition (VAD) and outside vapor deposition (OVD). In one embodiment, the preform includes a preform core formed from an un-doped material such as pure silica. The preform may include a preform cladding layer of an optical material such as silica having at least one dopant such as fluorine.

In the second stage 22, a length of optical fiber is drawn from the preform.

In the third stage 23, measurement units such as fiber Bragg gratings (FBGs) are fabricated in the optical fiber. The measurement units may be fabricated either during fiberization, such as on a fiber draw tower, or after fiberization. Exemplary methods of fabricating the FBG include techniques utilizing a femtosecond-pulsed laser. Such methods are not limited to those described herein, as any suitable method for fabricating a grating in a hydrogen resistant fiber core may be used.

Gratings can be written using a femtosecond laser using, e.g., phase masks or direct point-to-point writing. The laser may be operated at various wavelengths, including infrared (IR) and ultraviolet (UV) wavelengths. The femtosecond laser techniques described herein apply a series of high peak power femtosecond pulses to a core region to modify the index of the core. In one embodiment, “high” peak power refers to a peak power on the order of 100 kilo-watt (kW) or higher.

An exemplary point-by-point fabrication method utilizes a laser operating at an 800 nm wavelength and configured to produce femtosecond pulses as a selected pulse repetition rate, e.g., 150 femtosecond pulses at a repetition rate of 1 kHz. The pulse energy is approximately 0.5 μJ or higher. During operation of the laser, a translation stage moves the focused laser beam along the fiber core at a constant speed. The core region in which the grating is formed can be adjusted by adjusting the focusing conditions of the laser, and the grating period or pitch can be adjusted by changing the speed and/or pulse repetition rate.

An exemplary phase mask method includes applying a 264 nm, 180 GW/cm2 femtosecond pulsed laser to the optical fiber core. The laser is focused through a phase mask onto the core with a pulse repetition rate of 27 Hz and a pulse energy of up to 300 μJ. Various power or intensity levels may be used as desired. For example, IR lasers having intensity levels of about 10¹⁰ W/cm2 or 10¹⁴ W/cm2 may be used.

The gratings may be written in any selected radial or angular position via the femtosecond laser methods described herein. For example, the grating may be positioned centrally within the core, i.e., at or near the central longitudinal axis of the core, or offset radially from the central axis. In addition, multiple gratings may be written at different radial and/or angular positions, e.g., for detection of bending stresses.

The length and number of gratings is not limited. For example, a number of gratings having a selected length (e.g., 2 cm) may be written along a measurement portion of the hydrogen resistant fiber at a selected spacing, i.e., distance between individual gratings (e.g., 2 cm spacing or 10 cm). Gratings may be placed along any length of the optical fiber, such as the length of fiber that is connected to a drill string or that is deployed downhole. In this way, a distributed sensing system can be made that provides measurements along an entire length of a borehole or string (or along some length of interest) using a single continuous optical fiber.

In one embodiment, the gratings are written such that the length of fiber has a continuous or quasi-continuous grating. For example, using the methods described herein, an optical fiber may be written with a continuous grating extending along a selected length of the fiber. In another example, a plurality of gratings can be positioned very close to one another (end-to-end) to provide a near continuous measurement unit.

In the fourth stage 24, the optical fiber sensor is deployed in a borehole during a downhole operation. For example, the optical fiber sensor is deployed with a drill string during a drilling and/or logging-while-drilling (LWD) operation. The optical fiber sensor may be deployed with any type of borehole string or carrier, such as a wireline tool. Various measurements may be performed during the downhole operation, such as temperature, pressure, deformation, vibration and others.

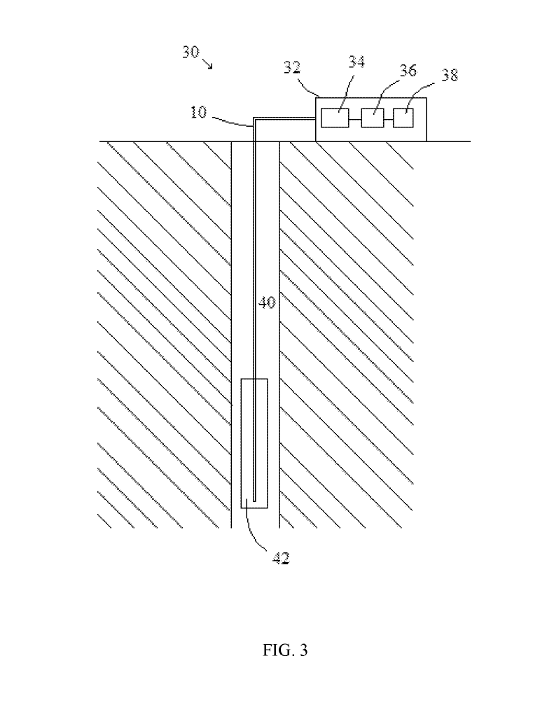

An example of an application of the optical fiber sensor 10 is shown in FIG. 3, in which a downhole measurement apparatus 30 is illustrated. The downhole measurement apparatus 30 is configured to measure various downhole parameters, such as strain, stress, temperature and pressure. The apparatus 30 includes a surface unit 32 and at least one optical fiber sensor 10 including a plurality of measurement units 16 such as fiber Bragg gratings (FBGs) distributed along a length of the optical fiber sensor 10.

The surface measurement unit 32 includes a tunable laser 34, a detector 36 and a processing unit 38. The detector 36 may be any suitable type of photodetector such as a diode assembly. The detector 36 is configured to receive return signals reflected from the measurement units (e.g., FBGs) 16 and generate measurement data.

The optical fiber sensor 10 is configured to be disposed in a borehole 40 and extend along a desired length of the borehole 40. Exemplary parameters that can be measured using the optical fiber sensor include temperature, strain, pressure, position, shape and vibration. The optical fiber sensor may be configured as and/or part of any of a variety of measurement apparatuses or systems. For example, the optical fiber sensor 10 may be configured as a temperature sensor, a strain sensor, a distributed temperature sensor (DTS), an interferometer, an optical frequency-domain reflectometry (OFDR) or optical time-domain reflectometry (OTDR) sensor, and a distributed sensing system (DSS).

In one embodiment, the optical fiber sensor 10 is disposed on or in relation to a carrier or tool 42, such as a drill string segment, downhole tool or bottomhole assembly. As described herein, a “carrier” refers to any structure suitable for being lowered into a wellbore or for connecting a drill or downhole tool to the surface, and is not limited to the structure and configuration described herein. Examples of carriers include casing pipes, wirelines, wireline sondes, slickline sondes, drop shots, downhole subs, BHA's, drill string inserts, modules, internal housings and substrate portions thereof.

For example, the optical fiber sensor may be disposed as part of a wireline cable, a wired pipe or any other type of borehole string, such as a drill string, a borehole completion, a production string or a stimulation assembly. The optical fiber sensor can be, for example, adhered or otherwise attached to a surface or interior portion of the borehole string to measure temperature, strain (e.g., axial, bending or torsional strain) or vibration of the string. In other examples, a length of the optical fiber sensor is exposed or otherwise operably connected to a sampling device or sample reservoir for evaluation of downhole fluids or other materials.

The apparatus 20 may be used in conjunction with methods for estimating various parameters of a borehole environment and/or the apparatus 20. For example, a method includes disposing the optical fiber sensor 10 and/or the carrier 42 downhole, emitting a measurement signal from the laser 34 and propagating the signal through the optical fiber 10. The Bragg gratings or other measurement units 16 reflect a portion of the signal back to the surface unit 32 through the optical fiber sensor 10. The wavelength of this return signal is shifted relative to the measurement signal due to parameters such as strain and temperature. The return signal is received by the surface unit 32 and is analyzed to estimate desired parameters.

The optical fibers, apparatuses and methods described herein provide various advantages over existing methods and devices. As discussed above, traditional FBGs are made by exposing photosensitive fiber, usually containing Germanium, to particular ultraviolet radiation patterns. Unfortunately, the same properties that make these fibers photosensitive also make them susceptible to hydrogen-induced loss. Fibers that are not susceptible to hydrogen induced loss, such as “pure core” or other hydrogen resistant fibers, are ideal for use downhole but are not photosensitive. Thus, in prior art techniques or operations that utilize photosensitive core FBGs as sensors, the fiber having FBGs must generally be kept short to minimize hydrogen induced degradation, and hydrogen insensitive fiber must be spliced in wherever possible. The addition of splices to traditional FBG fibers is uniquely challenging in downhole environments. This increases manufacturing costs and complexity, as well as introduces opportunities or damage and degradation of the fiber downhole.

The optical fiber sensors described herein provide the significant advantage of providing the ability to use a single fiber type without requiring any splicing in applications where FBGs must be used. Further, in downhole applications where distributed sensing is to be used, having such FBGs in pure core fiber opens up a large design space, where distributed sensing can be present over extended lengths without hydrogen induced degradation.

In connection with the teachings herein, various analyses and/or analytical components may be used, including digital and/or analog systems. The apparatus may have components such as a processor, storage media, memory, input, output, communications link (wired, wireless, pulsed mud, optical or other), user interfaces, software programs, signal processors (digital or analog) and other such components (such as resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention.

1. An apparatus for estimating at least one parameter in a downhole environment comprising:
an optical fiber configured to be disposed in a borehole, the optical fiber including a core having a first index of refraction and a cladding surrounding the core and having a second index of refraction that is lower than the first index of refraction, at least a portion of the core being made from a hydrogen resistant material;
at least one fiber Bragg grating (FBG) formed within the hydrogen resistant material;
a light source configured to send an optical signal into the optical fiber; and
a detector configured to receive a return signal generated by the at least one FBG and generate data representative of the at least one parameter.

2. The apparatus of claim 1, wherein an entire length of the optical fiber configured to be disposed in the borehole includes a continuous core made from the hydrogen resistant material.

3. The apparatus of claim 1, wherein the at least one FBG is a plurality of FBGs distributed along a selected length of the optical fiber.

4. The apparatus of claim 1, wherein the FBG is formed by applying a pulsed femtosecond laser to the core.

5. The apparatus of claim 1, wherein the hydrogen resistant material is at least substantially pure silica.

6. The apparatus of claim 1, wherein the hydrogen resistant material is an optically transparent material that has not been doped with germanium, phosphorous or boron.

7. The apparatus of claim 6, wherein the cladding is formed by an optically transparent material that includes a dopant configured to lower the second index of refraction.

8. A method of estimating at least one parameter in a downhole environment, the method comprising:
disposing an optical fiber in a borehole in an earth formation, the optical fiber including a core having a first index of refraction and a cladding surrounding the core and having a second index of refraction that is lower than the first index of refraction, at least a portion of the core being made from a hydrogen resistant material;
transmitting an optical signal into the optical fiber;
reflecting a portion of the optical signal by at least one fiber Bragg grating (FBG) formed within the hydrogen resistant material; and
detecting the reflected portion of the optical signal and estimating the at least one parameter.

9. The method of claim 8, wherein an entire length of the optical fiber configured to be disposed in the borehole includes a continuous core made from the hydrogen resistant material.

10. The method of claim 8, wherein the at least one FBG is a plurality of FBGs distributed along a selected length of the optical fiber.

11. The method of claim 8, wherein the FBG is formed by applying a pulsed femtosecond laser to the core.

12. The method of claim 8, wherein the hydrogen resistant material is at least substantially pure silica.

13. The method of claim 8, wherein the hydrogen resistant material is an optically transparent material that has not been doped with germanium, phosphorous or boron.

14. The method of claim 13, wherein the cladding is formed by an optically transparent material that includes a dopant configured to lower the second index of refraction.

15. The method of claim 8, further comprising estimating a downhole parameter via a processor based on the transmitted optical signal and the reflected portion of the optical signal.

16. A method of manufacturing an apparatus for estimating at least one parameter in a downhole environment, the method comprising:
forming at least one fiber Bragg grating (FBG) in a region of a core of an optical fiber, the optical fiber configured to be disposed in a borehole, the region of the core being made from a hydrogen resistant material; and
disposing a length of the optical fiber that includes the FBG at a carrier configured to be disposed in a borehole in an earth formation.

17. The method of claim 16, further comprising optically connecting a light source and a detector to the optical fiber, the light source configured to send an optical signal into the optical fiber and the detector configured to receive a return signal generated by the at least one FBG and generate data representative of the at least one parameter.

18. The method of claim 16, wherein the hydrogen resistant material is an optically transparent material that has not been doped with a photosensitive material that can react with hydrogen to cause optical loss.

19. The method of claim 16, wherein forming the at least one FBG includes focusing a high intensity femtosecond pulsed laser onto a region of the core.

20. The method of claim 19, wherein the laser is configured to emit light having a wavelength selected from at least one of an infrared and an ultraviolet wavelength.

21. The apparatus of claim 1, wherein the hydrogen resistant material is an optically transparent material that has not been doped with a photosensitive material that is reactive to hydrogen to cause optical loss.

22. The method of claim 8, wherein the hydrogen resistant material is an optically transparent material that has not been doped with a photosensitive material that is reactive to hydrogen to cause optical loss.
